(19) United States
(12) Patent Application Publication
(10) Pub. No.: US 2012/0256483 A1
(43) Pub. Date: Oct. 11, 2012

(54) ELECTRICAL CHARGE AND DISCHARGE SYSTEM, METHOD OF MANAGING A BATTERY AND A POWER GENERATOR, AND COMPUTER-READABLE RECORDING MEDIUM

(75) Inventors: Takeshi NAKASHIMA, Moriguchi-shi (JP); Souichi Sakai, Moriguchi-shi (JP); Ryuzo Hagihara, Moriguchi-shi (JP); Zenjirou Uchida, Takasaki-shi (JP)

(73) Assignee: SANYO ELECTRIC CO., LTD., Moriguchi-shi (JP)

(21) Appl. No.: 13/423,725

(22) Filed: Mar. 19, 2012

Related U.S. Application Data
(63) Continuation of application No. PCT/JP2010/072753, filed on Dec. 17, 2010.

(30) Foreign Application Priority Data
Dec. 17, 2009 (JP) 2009-286172

(51) Int. Cl. H02J 7/34

(52) U.S. Cl. 307/19

(57) ABSTRACT

This charge and discharge system comprises a battery connected to a bus to which multiple power a generator and an electric power transmission system are connected, a charger configured to supply power from the bus to the battery, a discharger separate from the charger and configured to output electric power from the battery to the bus, and a controller configured to separately control the charger and the discharger.

This application is a continuation of International Application No. PCT/JP2010/072753, filed Dec. 17, 2010, which claims priority from Japanese Patent Application No. 2009-286172, filed Dec. 17, 2009, the entire contents of which are incorporated herein by reference.

### FIELD OF INDUSTRIAL USE

The present invention relates to an electrical charge and discharge system, a method of managing a battery and a power generator, and a computer-readable recording medium, in particular, to a charge and discharge system provided with a battery, a method of managing a battery and a power generator, and a computer-readable recording medium.

### PRIOR ART

Conventionally, power generation systems which are provided with a power generator which generates electricity using renewable energy, and a battery which is capable of the storage of the electrical power generated by the power generator, are known.

Japanese laid-open published patent specification 2002-171674 discloses a solar cell, an inverter which is connected to the solar cell as well as to the power grid, one bi-directional chopper (DC-DC converter) which is connected to a bus to which the inverter and solar cell are also connected, and a battery connected to a charging and discharging means.

### PRIOR ART REFERENCES

### Patent References

Patent Reference #1: Japanese laid-open published patent specification 2002-171674

### Outline of the Invention

### Problems to be Solved by the Invention

However, in the Japanese laid-open published patent specification 2002-171674, charging and discharging are performed under the control of one DC-DC converter (bi-directional chopper). As a result, when switching over from charging and discharging, it was necessary to initiate discharge after the termination of charge.

In this type of configuration, wherein there is the operation of terminating the charge, time is taken to switch over from charging to discharging. As a result, in particular, in a system wherein there is a requirement to switch-over frequently between charging to discharging (e.g. a system wherein a storage battery is employed to smooth the fluctuation in the output of solar cells), the controllability of the electrical charge amount and the electrical discharge amount is reduced, and as a result, the precise control of the electrical charge and discharge amount becomes difficult.

This invention was conceived of to resolve the type of problems described above, and one object of this invention is the provision of an electrical charge and discharge system, a method of managing a battery and a power generator, and a computer-readable recording medium which records a control program for causing one or more computers to perform the steps wherein the precise control of the electrical charge and discharge amount is enabled.

### SUMMARY OF THE INVENTION

One aspect of the charge and discharge system of the present invention comprises a battery connected to a bus to which multiple power a generator and an electric power transmission system are connected, a charger configured to supply power from the bus to the battery, a discharger separate from the charger and configured to output electric power from the battery to the bus, and a controller configured to separately control the charger and the discharger.

### Effects of the Invention

By means of this invention, because the switch-over between electrical charge and discharge is enabled in a short time, the charge amount and the discharging amount can be controlled precisely. As a result, the high precision control of the charging and discharge amount is enabled.

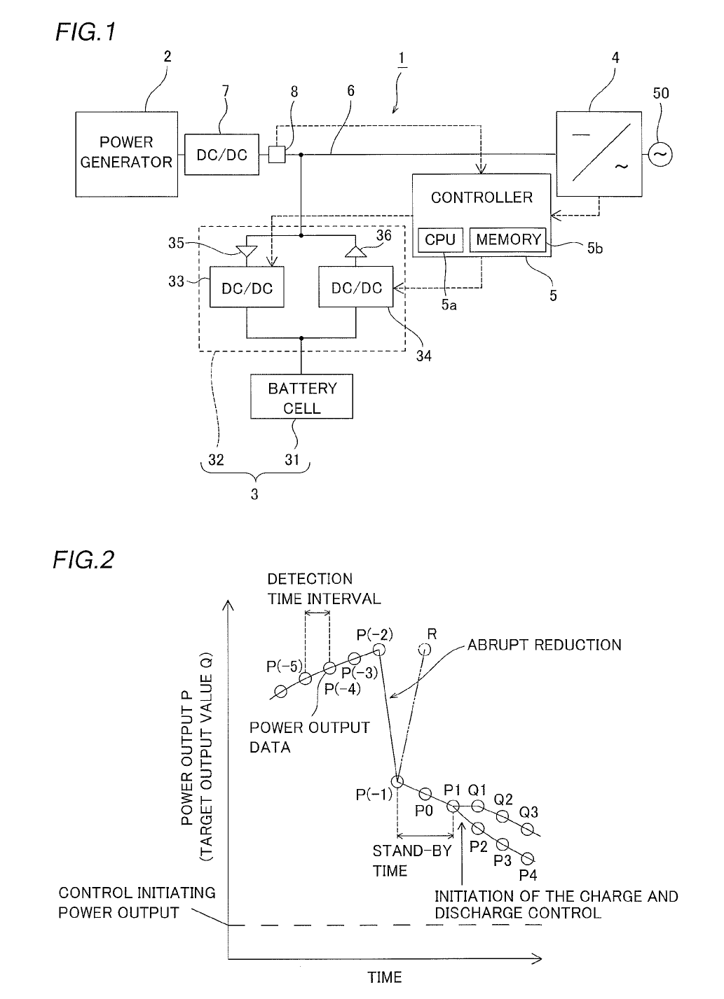

FIG. 1 is a block diagram showing the configuration of the power output system of the first embodiment of the invention.

FIG. 2 is a drawing to explain the transitions in the power output and the target output value when the electrical charge and discharge control of the power output system of the first embodiment shown in FIG. 1 is initiated.

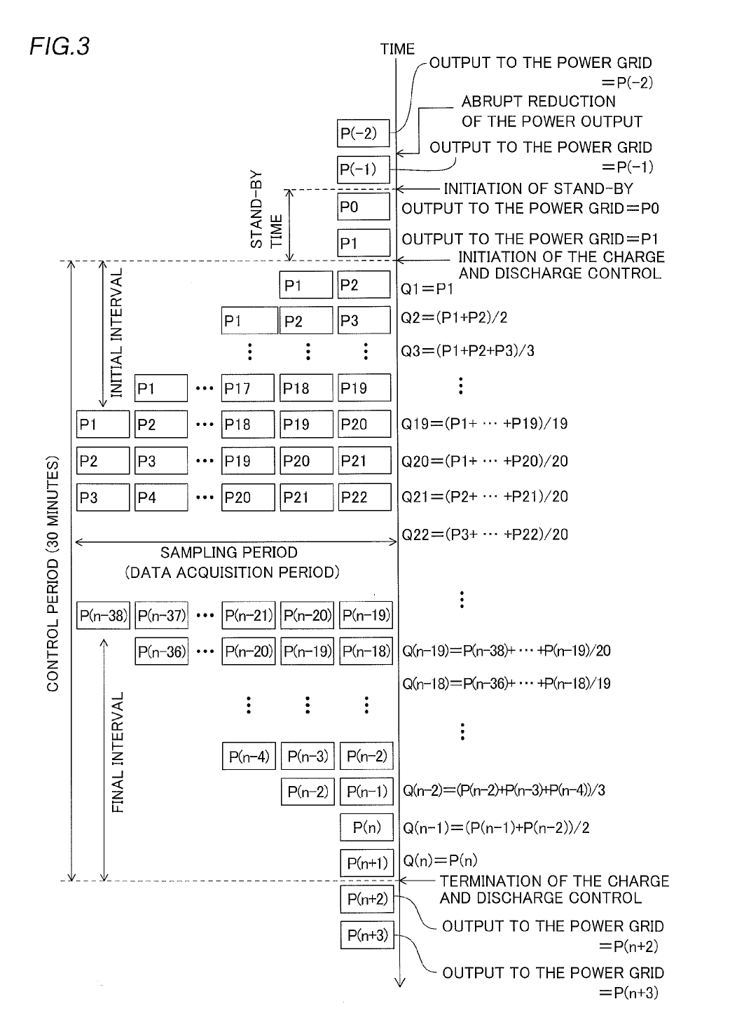

FIG. 3 is a drawing to explain the acquisition period for the power output data in order to compute the target output value on the occasion of the control of the charge and discharge of the power output system of the first embodiment shown in FIG. 1.

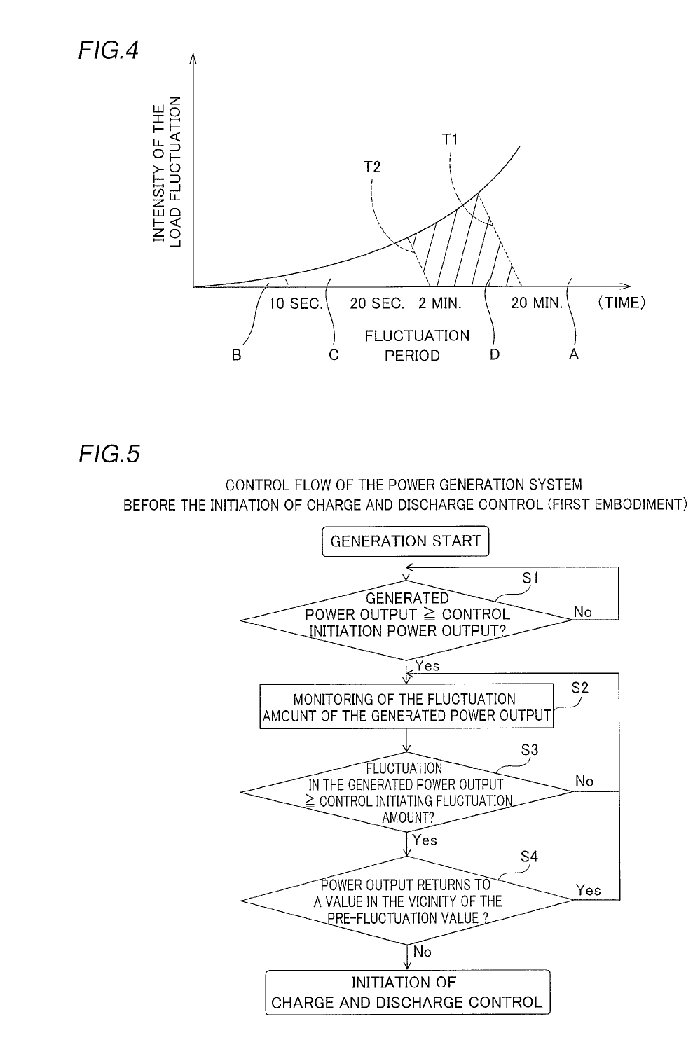

FIG. 4 is a drawing to explain the relationship between the intensity of the load fluctuation which can be output to the power grid, and the fluctuation period.

FIG. 5 is a flow chart to explain the control flow before the initiation of the control of the charge and discharge of the power generation system of the first embodiment shown in FIG. 1.

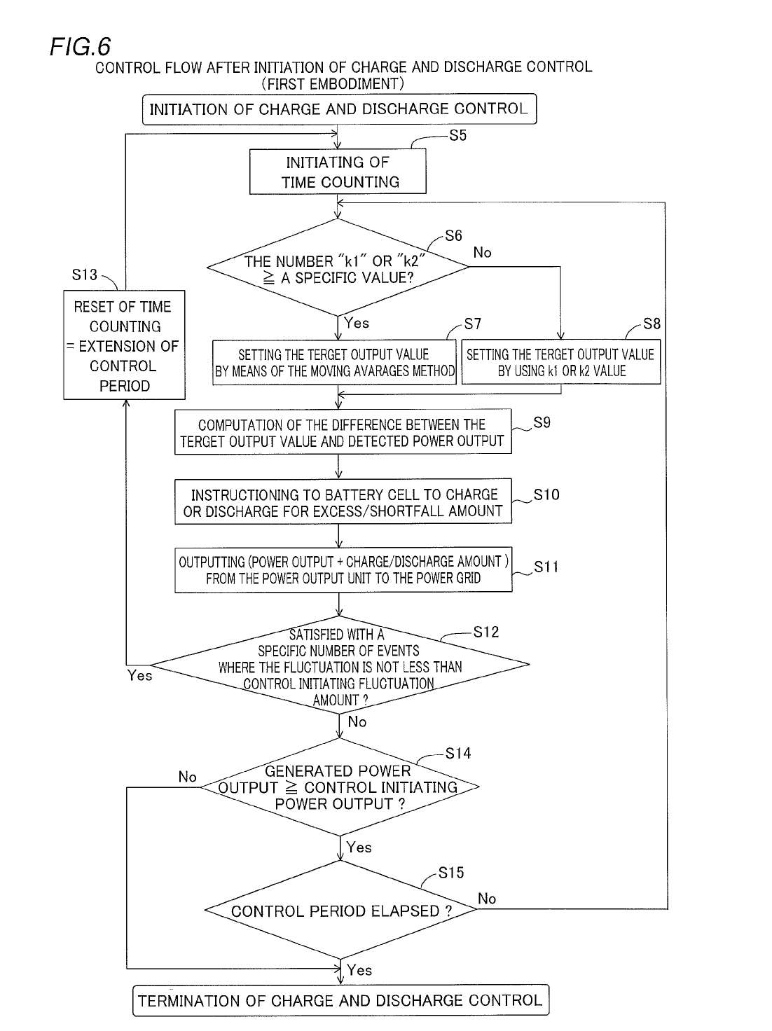

FIG. 6 is a flow chart to explain the control flow after the initiation of the control of the charge and discharge of the power generation system of the first embodiment shown in FIG. 1.

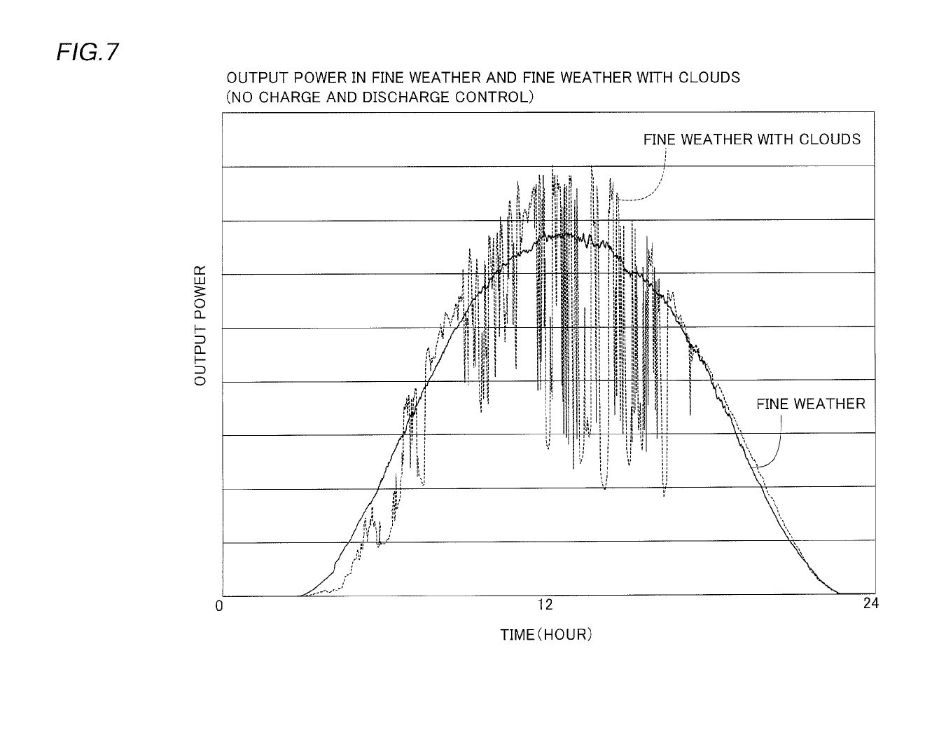

FIG. 7 is a graph showing the transitions (with no charge and discharge control) in one day of the amount of power output to the power grid in fine weather without clouds and fine weather with clouds.

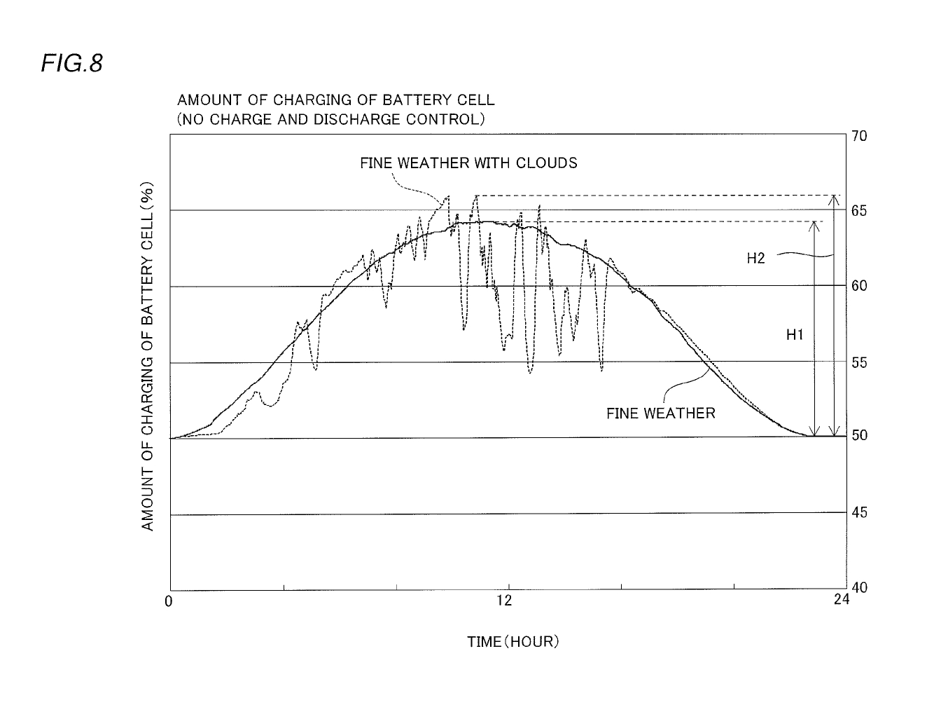

FIG. 8 is a graph showing the transitions (with no charge and discharge control) in one day of the amount of power storage by the storage battery in fine weather and in cloudy and fine weather.

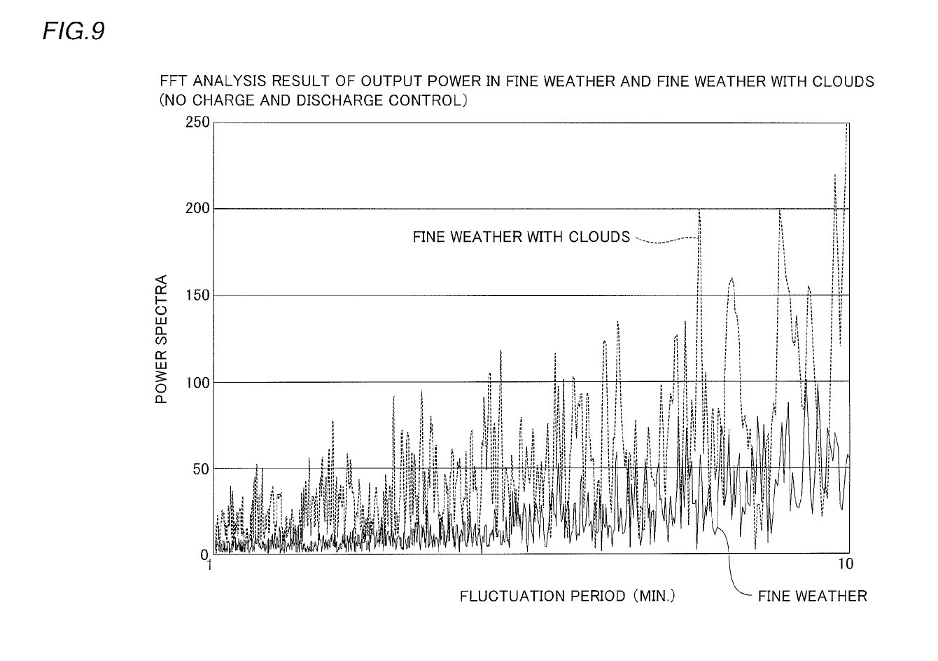

FIG. 9 is a drawing showing the analysis result of the analysis by the fast Fourier transform (FFT) method of the changes in the amount of the power output (with no charge and discharge control) to the power grid in the fine weather and in the cloudy and fine weather shown in FIG. 7.

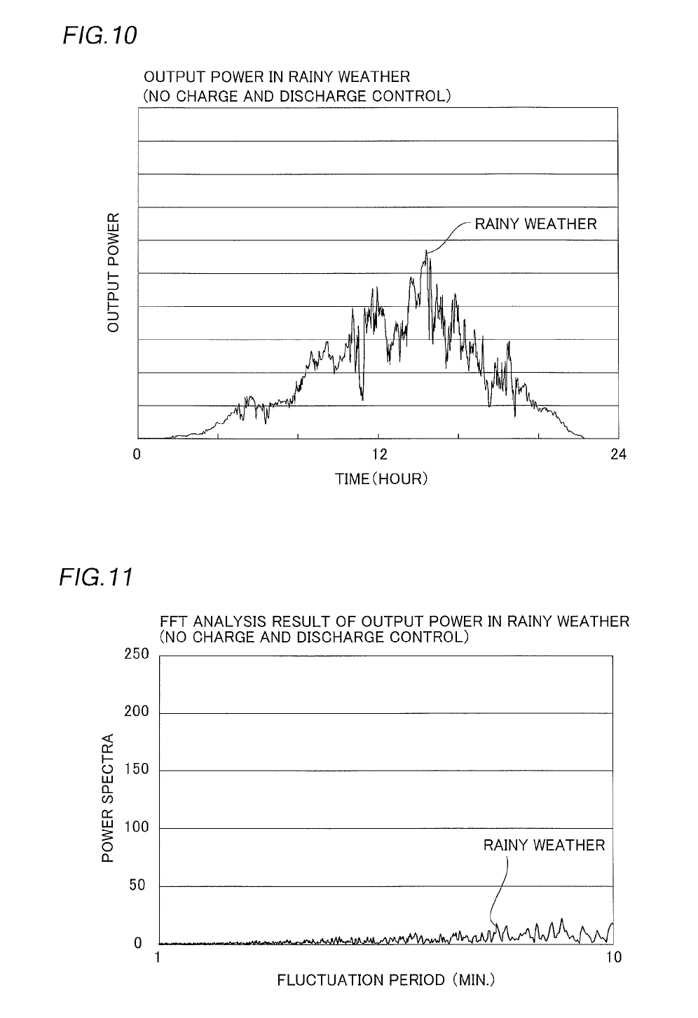

FIG. 10 is a graph showing the transitions (with no charge and discharge control) in one day of the amount of power output to the power grid in rainy weather.

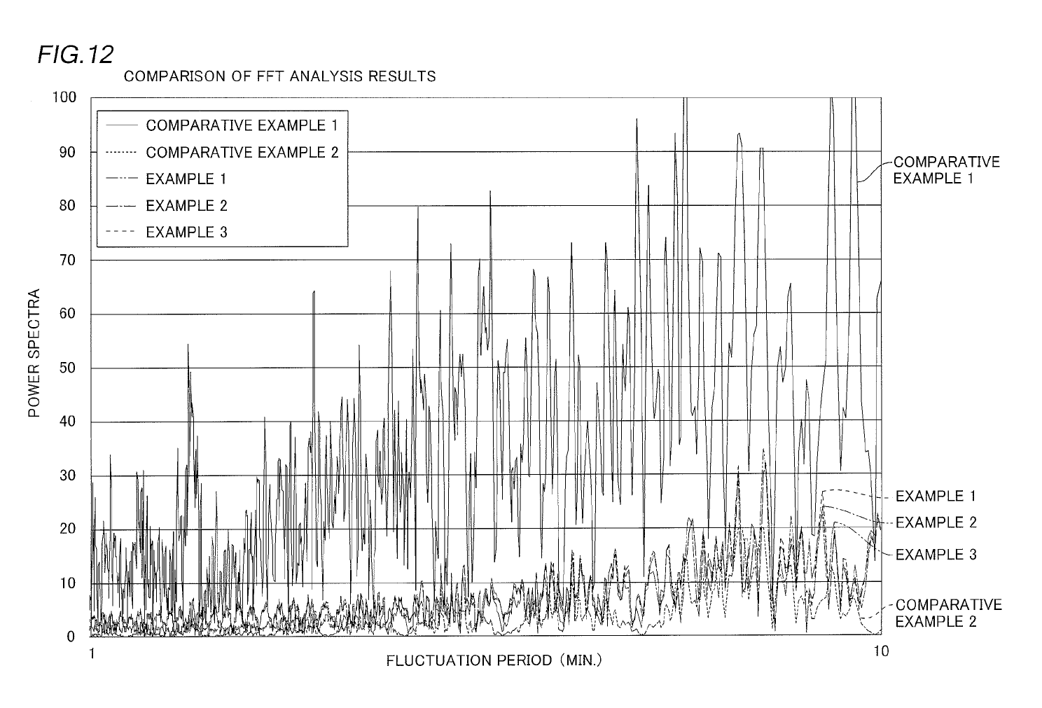

FIG. 11 is a drawing showing the analysis result of the analysis by the fast Fourier transform (FFT) method of the changes in the amount of the power output (with no charge and discharge control) to the power grid in the fine weather and in the rainy weather shown in FIG. 10.

FIG. 12 is a drawing showing the analysis result of the analysis by the fast Fourier transform (FFT) method of the investigation of the alleviation effectiveness on the deleterious effects to the power grid by means of the performance of the charge and discharge control.

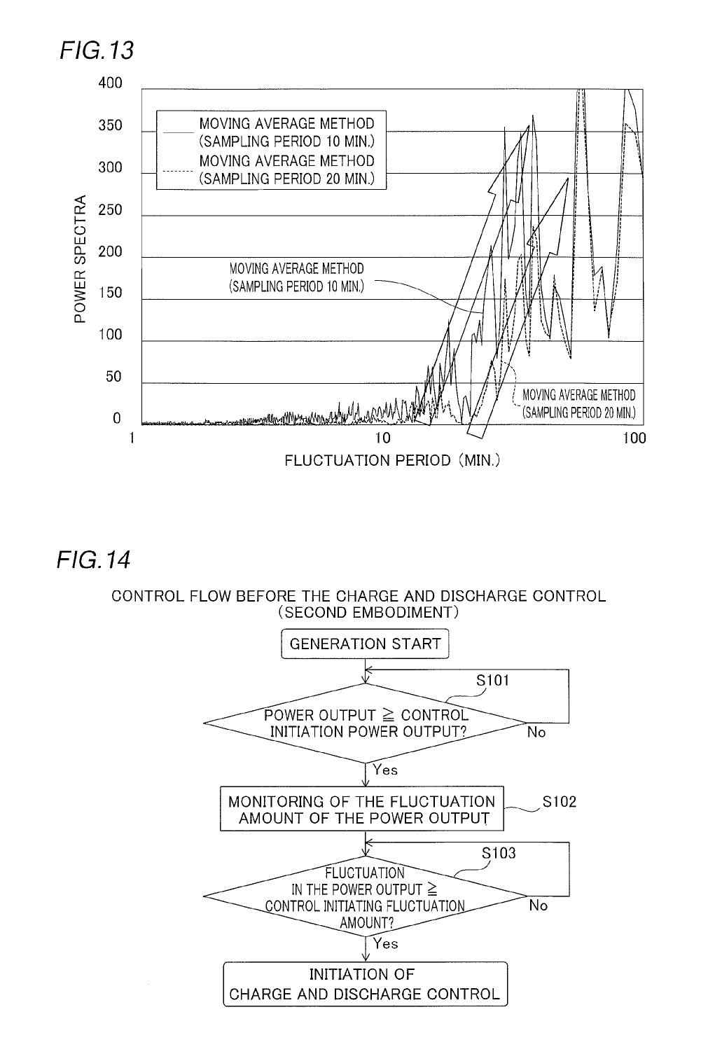

FIG. 13 is a drawing to explain the sampling interval in the charge and discharge control.

FIG. 14 is a flow chart to explain the control flow before the initiation of the control of the charge and discharge of the electrical generating system of the second embodiment of the invention.

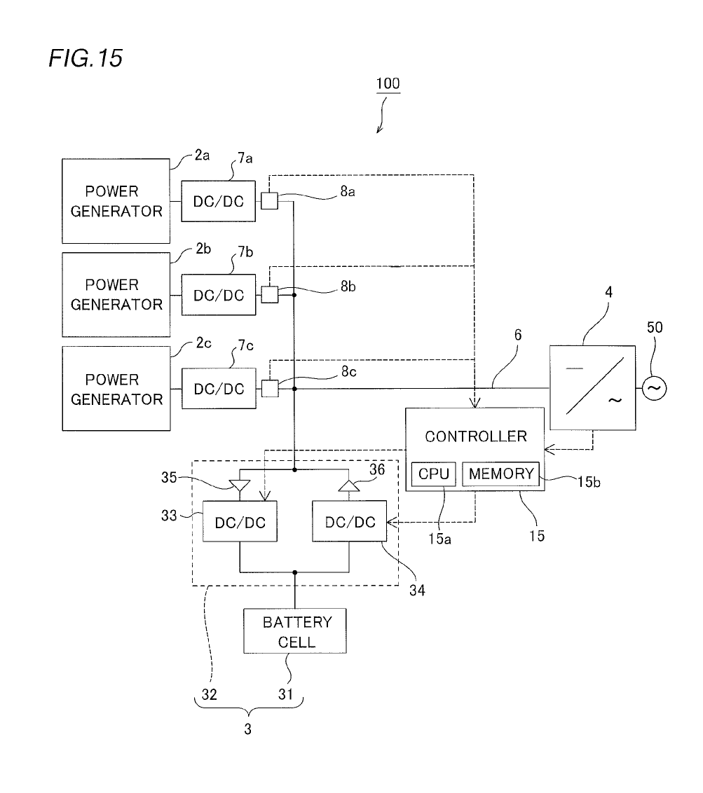

FIG. 15 is a block diagram showing the configuration of the power output system of the third embodiment of the invention.

### BEST MODE OF EMBODYING THE INVENTION

Hereafter the embodiments of the present invention are explained based on the figures.

### First Embodiment

Firstly, the configuration of the power output system of the first embodiment of the invention is explained while referring to FIG. 1 to FIG. 4.

The solar power output system 1 provides a power generator 2 comprised of a solar cell which generates power using the light of the sun, and a battery 3 capable of the storage of the electrical power generated by means of the power generator 2, and an electrical power output unit 4, connected to the power grid 50, including an inverter outputting the electrical power generated by means of the power generator 2 and the electrical power stored by means of the battery 3, and a controller 5 controlling the electrical charge and discharge of the battery 3.

There is a DC-DC converter 7 connected in series with the bus 6 to which the power generator 2 and the power output unit 4 are connected. The DC-DC converter 7 has the function of converting the DC voltage of the electrical power generated by means of the power generator 2 to a fixed DC voltage (Approximately 260 V in the first embodiment) and the output thereof to the power output unit 4. Moreover, the DC-DC converter 7 has the so-called maximum power point tracking (MPPT) control function. The MPPT function is the function of the automatic adjustment of the operational voltage of the power generator 2 so as to maximize the electrical power generated by means of the power generator 2. The DC-DC converter 7 is an example of the “First DC-DC converter” in the present invention. A diode (not shown in the figures) is provided between the power generator 2 and the DC-DC converter 7. The diode is to prevent the reverse flow of the electrical current flowing towards the power generator 2.

The battery 3 includes the battery cell 31, and the charge and discharge unit 32 in order to charge and discharge the battery cell 31. The battery cell 31 and the power generator 2 are both connected in parallel to the bus 6. Secondary battery cells (for example, a lithium ion battery cell, or a Ni-MH battery cell, or the like) which have little natural discharge and high electrical charge and discharge efficiency may be employed as the battery cell 31. The voltage of the battery cell 31 is approximately 48 V. The storage battery 31 is an example of the “battery” in the present invention.

The charge and discharge unit 32 has the DC-DC converters 33 and 34. The DC-DC converters 33 and 34 in between the bus 6 and the battery cell 31 are mutually connected in parallel. The DC-DC converter 33 is used on the occasion of the electrical charging of the battery cell 31 by the electrical power generated by the power generator 2.

On the occasion of the electrical charging, the DC-DC converter 33 supplies electrical power from the bus 6 side to the battery cell 31 side by reducing the voltage of the electrical power supplied to the battery cell 31 from the voltage from the bus 6 to a voltage suitable for charging the battery cell 31. A diode 35 is provided between the bus 6 and the DC-DC converter 33 regulating (rectifying) the current in the electrical charge direction. The DC-DC converter 33 is an example of the “the second DC-DC converter” in the present invention. The diode 35 is an example of the “first rectifier” in the present invention.

The DC-DC converter 34 is used on the occasion of the electrical discharge from the battery cell 31 to the electric power output unit 4. On the occasion of electrical discharge, the DC-DC converter 34 discharges power from the battery cell 31 to the bus 6 side by raising the voltage of the power discharged to the bus 6 side from the voltage of the battery cell 31 to that of near to the voltage of the bus 6 side. A diode 36 is provided between the DC-DC converter 34 and the bus 6 in order to regulate (rectify) the direction of the current flow to the direction of electrical discharge. The DC-DC converter 34 is an example of the “third DC-DC converter” in the present invention. The diode 36 is an example of the “second rectifier” in the present invention.

The controller 5 includes the CPU 5a and the memory 5b. The controller 5 performs the charge and discharge control of battery cell 31 by means of the mutually independent control of the DC-DC converters 33 and 34. Specifically, the controller 5 performs the discharge of battery cell 31 in a manner such as to compensate for the difference between the power output by the power generator 2 and the target output value, based on the power output by the power generator 2 (the output electrical power of the DC-DC converter 7), and the later-described target output value. In other words, in the event that the power output by the power generator 2 is greater than the target output value, the controller 5 controls the DC-DC converter 33, dedicated to charging, to charge the battery cell 31 with the excess electrical power. In the event that the power output by the power generator 2 is less than the target output value, the controller 5, controls the DC-DC converter 3, dedicated to discharging, to discharge the battery cell 31 to make up for the shortfall in the electrical power.

The detection unit 8 for the power output which detects the power output by the power generator 2 is provided on the output side of the DC-DC converter 7. The controller 5 can acquire power output data for each specific detection time interval (e.g. less than 30 seconds), based on the output results of the detection unit 8 for the power output. The controller 5 acquires power output data by the power generator 2 every 30 seconds. Because the fluctuation in the power output cannot be detected accurately if this detection time interval of the amount of the electricity is too long or too short, there is a need to set an appropriate value in consideration of the fluctuation period of the amount of the power output by the power generator 2. In this embodiment, the detection time interval is set to be shorter than the fluctuation period which can be responded to by means of the load frequency control (LFC), as well as being shorted than the later described stand-by time.

The controller 5, recognizes the difference between the actual power output by the power output unit 4 to the power grid 50 and the target output value, by acquiring the output power of the electrical power output unit 4. By this means, the controller 5 enables feedback control on the electrical charge and discharge by the charge and discharge unit 32 such that the power output from the power output unit 4 becomes that of the target output value.

The controller 5 is configured in order to compute the target output value to the power grid by using the moving average method. The moving average method is a computation method employing an average of the power generated by the power generator 2 in a period prior to a certain point as a target output value at a certain point, for example.

Hereafter, the periods in order to acquire the power output data using in the computing the target output value are called the sampling intervals. The sampling intervals are between the fluctuation periods T1˜T2 corresponding to the load frequency control, in particular, preferably are of a range which are not very long periods greater than the vicinity of the latter half from T1 (in the vicinity of long periods). As a specific example of the value for the sampling interval, for example, they are intervals of greater than 10 minutes and less than 30 minutes in respect of the power grid having the characteristics of the “intensity of load fluctuation period” shown in FIG. 4. In this embodiment, in the intervals, other than the initial interval and the final interval, the sampling interval is set at approximately 10 minutes. In this situation, because the controller 5 acquires the power output data approximately every 30 seconds, the target output value is computed from the average value of 20 power output data samples in the last 10 minute interval. There will be a detailed explanation provided below in respect of the upper limit period T1 and the lower limit period T2. The sampling interval is an example of the “acquisition period of power output data”.

As described above, the controller 5 computes the target output value from the power output by the power generator 2 in the past, and controls the charge and discharge of the battery cell 31 such that the total of the power output by the power generator 2, and the amount of the electrical charge and discharge of the battery cell 31 equals the target output value, and performs the charge and discharge control to output the target output value to the electric power system. By this means, the fluctuation in the amount of power output to the power grid 50 is suppressed compared to the power output by the power generator 2, enabling smoothing.

The controller 5 does not exert the charge and discharge control when the adverse effects on the power grid 50 of the output of the power output by the power generator 2 are small, and is configured to only exert the charge and discharge control when the adverse effects would be great. Specifically, the controller 5 when the power output by the power generator 2 is not less than a specific power output (hereafter referred to as “control initiating power output ”), moreover, when the amount of fluctuation in the power output by the power generator 2 is above a specific value (hereafter referred to as “control initiating fluctuation amount”), the controller 5 is configured to perform the charge and discharge control.

The control initiating power output is, for example, when the power output is greater than the power output during rainy weather, and may be, for example, 10% of the rated power output of the power generator 2. The control initiating fluctuation amount may be an amount of fluctuation which is greater than the maximum amount of fluctuation for each detection time interval in the time period around noon on fine weather (a sunny day with almost no clouds), for example, 5% of the amount of the power output before the fluctuation of the power generator 2. The amount of fluctuation in the power output is acquired by computing the difference in two sequential power output data by the power generator 2 as detected in the specific detection time intervals.

When the amount of the power output by the power generator 2 moves from a state where it is less than the control initiating power output to a state where it is not less than the control initiating power output amount, the controller 5 initiates the detection of the amount of fluctuation in the power output by the power generator 2. In that state, when the amount of fluctuation in the power output by the power generator 2 becomes further increased above the control initiating fluctuation amount, the controller 5 initiates the charge and discharge control for the first time. While the amount of fluctuation in the power output by the power generator 2 is less than the control initiating fluctuation amount, and while the power output by the power generator 2 is less than the control initiating power output, the controller 5 stops detecting the amount of fluctuation in the power output by the power generator 2.

Even when the amount of fluctuation in the power output by the power generator 2 is not less than the control initiating fluctuation amount, when the value for the power output returns to the pre-fluctuation value, within a specific stand-by time from the point in time when the detection in the fluctuation was made, the adverse effect on the power grid is small. Therefore, in this type of situation, the controller 5 does not initiate the charge and discharge control.

The specific stand-by time described above is a period which is not more than the fluctuation period which the load frequency control (LFC) can deal with. On referring to the fluctuation period—load fluctuation relationship curve shown in FIG. 4, the specific stand-by time is a period preferably not more than the upper limit period T1, and even more preferably a period of not more than the lower limit period T2. In this embodiment, the specific stand-by time was set at approximately less than 2 minutes. The specific stand-by time is not less than twice the detection time interval (for example, an integral multiple not less than twice the detection time interval).

The value in the vicinity of the pre-fluctuation power output is the value between the upper-side threshold value so slightly greater in respect of the power output of the pre-fluctuation and the lower-side threshold value so slightly smaller in respect of the power output of the pre-fluctuation. The upper side threshold value, for example, is a power output which is a value of 101% of the pre-fluctuation value. The lower side threshold value, for example, is a power output which is a value of 99% of the pre-fluctuation value.

Moreover, in the event that the fluctuation in the power output is a decrease which is not less than the control initiation fluctuation amount, after the reduction in the amount of power generated, if there is a rise to a value not less than the lower threshold value (99% of the power output before the fluctuation) within the stand-by time, the controller 5 reaches a determination to return the value to the vicinity of the power output before the fluctuation. Moreover, in the event that the fluctuation in the power output is an increase which is not less than the control initiation fluctuation amount, after the power output rises, if it drops to a value not more than the upper threshold value (101% of the power output before the fluctuation) within the stand-by time, the controller 5 reaches a determination to return the value to the vicinity of the power output before the fluctuation. That is, in the event the fluctuation in the power output is either a decrease or an increase, the two threshold values, the standard of the determinations to return the value to the vicinity of the power output before the fluctuation, are different from each other.

A specific explanation is provided while referring to FIG. 2. In the event that the power output is abruptly reduced from power output P (−2) to power output P (−1), in the event that the value does not return to the value of the vicinity of the power output P (−2) from the point when the power output P (−1) is detected within the stand-by time, the controller 5 initiates the charge and discharge control. In this embodiment, the stand-by time is set at one minute. The detection of power output P0 or power output P1 within the stand-by time after the detection of power output P (−1) are not the values in the vicinity of the power output P (−2). For this reason, the controller 5, initiates the charge and discharge control at the point that the power output P1 is detected. In the event that a value R (a value R which is not less than 99% of the lower threshold value of power output P (−2)) in the vicinity of the power output P (−2) is detected within the stand-by time after the power output P (−1), the controller 5 reaches a determination to return the value to the vicinity of the power output P (−2) before the fluctuation, and does not initiate the charge and discharge control.

The controller 5 is configured such that after the controller 5 initiates the charge and discharge control, and after a specific control period has elapsed, the charge and discharge control is suspended.

The control period is at least not less than the sampling period determined based on the fluctuation period range in correspondence to the load frequency control. In the event that a procedure is adopted to shorten the data acquisition period of the power output data in either the initial or final period of the charge and discharge control, the control period has as a minimum period of the sampling period with the shortened data acquisition period added thereto. When the control period is too short, the control effectiveness in the fluctuation period range, corresponding to the load frequency control, becomes weak. On the other hand, when the control period is too long, the frequency of the number of instances of charge and discharge increases, resulting in the reduction in the lifetime of the battery cell. Therefore, there is a need to set the control period to an appropriate duration. In this embodiment, the control period was set to 30 minutes. The control period is an example of the “second period” in the present invention.

In the event that there is the detection of a specific number (3 times, in the first embodiment) of instances of fluctuation of the power output of not less than the control initiation fluctuation amount in the control period, the controller 5 is configured to extend the control period. This extension, on the occasion of the detection of the third fluctuation of the power output, is performed by the setting anew of a 30-minute control period. In the event that the control period is extended, and in the event that there is not another detection of three instances of power output fluctuation not less than the control initiating fluctuation amount from the third detection point (the initiation point of the extension), the controller 5 terminates the charge and discharge control 30 minutes after the detection of the third detection point (the initiation point of the extension). In the event that after the detection of the third detection point (the initiation point of the extension), there is the detection of another three instances of fluctuation of the power output of not less than the control initiation fluctuation amount, there is yet another 30 minute extension.

In the control period, in the event that the power output of the power generator 2 is less than the control initiating power output, even if the control period has not yet elapsed, the controller 5 is configured to terminate the charge and discharge control.

Next, the computation method of the target output value by means of the controller 5 of the solar light power generation system 1 is explained, while referring to FIG. 2 and FIG. 3.

As shown in FIG. 2, it is a hypothetical example where as the power output rises gradually, when there is an abrupt power output fluctuation (reduction) occurring at a timing between a certain detected power output (power output P (−2)) to the next detected power output (power output P (−1)), thereafter, the power output continues to decline, without returning to the detected power output (power output P (−2)) before the fluctuation.

In the event that there is an abrupt fluctuation in the power output as shown in FIG. 2, in respect of the periods other than the initial period and the final period of the charge and discharge control, as shown in FIG. 3, the controller 5 computes the target output value from the mean value of 20 power output data samples included in the past 10 minute long sampling period. On the extremes thereof, in the initial period of the charge and discharge control (the 10 minutes from when the charge and discharge control was initiated) and in the final period (the 10 minutes until the termination of the charge and discharge control is planned), the controller 5 is configured to compute the target output value from the power output data in periods shorted than the power output data sampling period (10 minutes, 20 power output data samples) in the period other than the initial and final charge and discharge control periods.

Specifically, in the initial period of the charge and discharge control, the controller 5 not only sequentially accumulates the power output data (P1, P2 . . . ) from the start of the charge and discharge control onwards in memory 5b, but also gradually increases the sampling period for the power output data from the start of the charge and discharge control, in correspondence with the accumulated amount.

In other words, to explain the situation whereby between the power output P (−2) detected at a certain timing of the detection of the power output, and the next power output P (−1) at the next timing of the detection of the power output, there is a big fluctuation generated, moreover, if there is the recognition that the power output does not return to the vicinity of the power output P (−2) within the stand-by time such that the charge and discharge control is initiated.

In that situation, the first target output value Q1, after the initiation of the charge and discharge control, is that same power output data P1 acquired immediately before. The second target output value Q2 is the mean of the two power output data accumulated in memory 5b (the power output data P1 and P2 acquired immediately prior). The third target output value Q3 is the mean of the three power output data accumulated in memory 5b (the power output data P1, P2 and P3 acquired immediately prior). In the same manner, the 20^{th} target output value Q20 is the mean of the 20 power output data (P1˜P20) acquired most recently and accumulated in memory 5b. At the point where the accumulated amount of data on the power output reaches 20, there is transition from the initial period to a period excluding the initial period and the final period. Then, after the number of accumulated data reaches 20 (in the period excluding the initial and final periods) the target output value is computed based on 20 power output data samples.

When the termination point of the charge and discharge control approaches (Planned termination point), the sampling period for the power output data is gradually reduced in accordance with the planned acquisition amount of the power output data to the end point of the charge and discharge control. Because the planned termination time point of the charge and discharge control is 30 minutes from the start (or extended start), the starting point for the reduction in the sampling period for the power output data can be computed. At the point when the charge and discharge control reaches 10 minutes before the planned termination point, as well as moving from the periods, other than the initial period and the final period, the sampling period for the power output starts to be reduced from the initiation point of the final period.

Specifically, near the end point of the charge and discharge control (Planned termination point), on computation of the target output value for the nth time since the start of the control, the target output value Q (n−19), of the 20^{th} time before the end of the control, is computed from the mean of the immediately prior 20 power output data samples P (n−38)˜P (n−19). The target output value Q (n−18), of the 19^{th} time before the end of the control, is computed from the mean of the immediately prior 19 power output data samples P (n−36)˜P (n˜18). In the same manner, the target output value Q (n−2), of the third time before the end of the control, is computed from the mean of the immediately prior three power output data samples P (n−4), P (n−3) and P (n−2). The target output value Q (n−1), of the second last time before the end of the control, is computed from the mean of the immediately prior two power output data samples P (n−2) and P (n−1). Then the target output value Q (n), of the last time before the end of the control, is the immediately prior power output data sample P (n) itself.

Here, an explanation is provided of the fluctuation period range performed mainly in the fluctuation suppression by means of the charge and discharge control. As shown in FIG. 4, the suppression method is different in accordance with the ability to respond to the fluctuation period. The domain D (The domain shown shaded) shows a fluctuation period where the load can be dealt with by means of the load frequency control. The domain A shows a fluctuation period where the load can be dealt with by means of the EDC. The domain B is a domain where the effects of the load fluctuation can be naturally absorbed by the endogenous control of the power grid 50. The domain C is a domain which can be dealt with by the governor free operation of the generators in each power generating location.

The border line between domain D and domain A corresponds to the upper limit period T1 of the fluctuation periods of the loads which can be dealt with by the load frequency control. The border line between domain C and domain D corresponds to the lower limit period T2 of the fluctuation periods of the loads which can be dealt with by the load frequency control. Based on FIG. 4, the upper limit period T1 and the lower limit period T2 are not characteristic periods, and they can be understood to be numerical values fluctuating with the intensity of the load fluctuations.

The duration of the fluctuation period drawn fluctuates with the configuration of the power grid. In this embodiment, looking at the load fluctuation which the fluctuation periods (fluctuation frequencies) have and are included in the range of the domain D (a domain which LFC can deal with) but which governor free operation or endogenous control of the power grid 50 and EDC cannot deal with, the objective is to suppress the load fluctuation.

Next, while referring to FIG. 5, an explanation is provided of the flow of control before the charge and discharge control of the solar power generation system 1 is initiated.

The controller 5 detects the power output of the power generator 2 at specific detection duration intervals (every 30 seconds). Then in Step S1, the controller 5 makes a determination as to whether the power output is not less than the control initiation power output or not. In the event that the power output is not less than the control initiation power output, that determination is repeated. In the event that the power output is not less than the control initiation power output, then in Step S2, the controller 5 initiates to monitor the fluctuation amounts of the power output. In other words, the difference between the detected power output and the immediately prior detected value for the power output is acquired as the fluctuation in the power output. [0050]

In Step S3, the controller 5 makes a determination as to whether the fluctuation in the power output is not less than the control initiating fluctuation amount. In the event that the fluctuation amount of the power output is not less than the control initiating fluctuation amount, it returns to Step S2, and the controller 5 continues to monitor the fluctuation amount of the power output.

In the event that the fluctuation amount of the power output is not less than the control initiating fluctuation amount, in Step S4, the controller 5 makes a determination as to whether the power output returns to a value in the vicinity of the pre-fluctuation value or not within the stand-by time or not. In the event that the power output returns to a value in the vicinity of the pre-fluctuation value, the controller 5 returns to Step S2, without performing the charge and discharge control, and continues to monitor the fluctuations. In the event that the power output does not return to a value in the vicinity of the pre-fluctuation value, the controller 5 initiates the charge and discharge control.

Now while it is not included in FIG. 5 the controller 5, for example, when monitoring the fluctuation amount of the power output in Step S2, the absolute value of the power output is checked, and when the power output is less than the control initiation power output, then it may be configured to return to Step S1.

Next, a detailed explanation is supplied of the flow of the control after the charge and discharge control is initiated, while referring to FIG. 6.

After the initiation of the charge and discharge control, in Step S5, the controller 5 initiates to count the elapsed time since the initiation point of the charge and discharge control.

Next in Step S6, the controller 5 makes a determination as to whether the number of accumulated power output data samples (The number of sampling times k1) since the initiation of the charge and discharge control, or the number of remaining planned sampling times k2 until the end of the charge and discharge control is not less than a specific value, or not.

In the event that the number of samples k1 of the power output data, or the number of remaining planned sampling times k2 are more than 20, in Step S7, the controller 5 sets the computation of the target output value by means of the moving average method using the most recent 20 sampling values.

In the event that the number of samples k1 of the power output data, or the number of remaining planned sampling times k2 are less than the prescribed number (20), in Step S8, the controller 5 sets the computation of the target output value by means of the moving average method using k1 or k2 sampling value. In other words, on the initiation of the charge and discharge control, the controller 5 increments the sampling number used in computing the target output value by one for each time from the target output value is computed 1 to 20. On the (planned) termination of the charge and discharge control, the controller 5 reduces the sampling number used in the computation of the target output value by one for each time the target output value is computed from 20 to 1.

In step S9, the controller 5 computes the difference between the target output value set in Steps S7 or S8, and the detected power output after the target output value was computed. Then, in step S10, the controller 5 instructs the charge and discharge unit 32 on the excess or shortfall of charge and discharge power. In other words, in the event that the target output value is greater than the actual power output, the controller 5 instructs the DC -DC inverter 34 to discharge power and the shortfall in the power output in respect of the target output value from the power generator 2 is made-up by battery cell 31. Moreover, in the event that the target output value is less than the actual power output, the controller 5 instructs the DC-DC converter 33 to charge in order that the excess after the target output value is subtracted from the actual power output from the power generator 2 is charged into battery cell 31.

In Step S11, the target output value (the power output from the power generator 2 +charge or discharge amount from the battery cell 31) is output from the power output unit 4 to the power grid 50.

Thereafter, in Step S12, the controller 5 makes a determination as to whether there has been a fluctuation of the power output of more than a specific amount (The control initiating fluctuation amount) on a specific number of occasions (3 times in the first embodiment) or not. In the event that there has been a fluctuation of the power output of more than the control initiating fluctuation amount on 3 occasions, the probability that the fluctuation in the power output will continue thereafter is high. For this reason, in Step S13, the controller 5 resets the count of the elapsed time, and the period of the charge and discharge control is extended. In that event, there is a return to Step S5, and the controller 5 initiates a new count of the elapsed time.

In the event that there has been a fluctuation of the power output of more than the control initiating fluctuation amount on less than three occasions, in Step S14, the controller 5 makes a determination as to whether the power output of the power generator 2 exceeded a specific power output amount (the control initiating power output amount) or not. Then in the event that the power output exceeded the control initiating power output amount, in Step S15, the controller 5 makes a determination as to whether the control period (30 minutes) from when the charge and discharge control was initiated, or from when the charge and discharge control was extended, has been exceeded or not. In the event that the control period has been exceeded, the controller 5 terminates the charge and discharge control. In the event that the control period has not been exceeded, there is a return to Step S6 and the controller 5 continues the charge and discharge control.

If, in Step S14, a determination is made that the power output of the power generator 2 is less than the control initiating power output amount, even if the control period has not been exceeded, the controller 5 terminates the charge and discharge control.

In the first embodiment, as described above, there is the provision of the controller 5 separately controlling the each of the DC-DC converter 33 performing the charging of the battery cell 31 and the DC-DC converter 34 performing the discharging of the battery cell 31. By this means, for example, on the occasion of the switch-over from charge to discharge, simultaneous with the termination of the charging of the battery cell 31 by the DC-DC converter 33, the initiation of the discharging of the battery cell 31 by the DC-DC converter 34 is enabled. By this means, because the switch-over between charge and discharge is enabled in a short time, the precise control of the charging power and the discharging power is enabled. As a result, the precise control of the charge and discharge power is enabled. Moreover, by the fitting of the DC-DC converter 33 and the DC-DC converter 34 to the battery 3, compared with when the charging means and the discharging means were incorporated in one device, for example, the improvement in the thermal radiation is enabled, enabling a further improvement in the reliability.

Moreover, in the first embodiment, as described above, when the controller 5 performs charge and discharge control when the power output generated, as detected by the detection unit 8, is in excess of the control initiating power output, moreover, when the fluctuation amount of the power output is not less than the control initiating fluctuation amount, the charge and discharge control is performed. By enabling this type of configuration, because there is no performance of the charge and discharge control when the conditions are not satisfied, the number of times the battery 3 is charged and discharged can be reduced. Furthermore, as a result of intense investigation, the inventors discovered that when the power output of the power generator 2 is less than the control initiating power out, and when the fluctuation amount of the power output of the power generator 2 is less than the control initiating fluctuation amount, even if the charge and discharge control is not performed, the effects on the power grid 50 caused by the fluctuations in the power output from the power output device are small. Therefore, in the present invention, while suppressing the effects on the power grid 50 caused by the fluctuations in the power output from the power generator 2, a contrivance at lengthening the lifetime of the battery 3 is enabled.

Moreover, in the first embodiment, as described above, the control initiating power output, for example, is a power output which is greater than the power output in rainy weather. By enabling this type of configuration, even if the charge and discharge control is not performed, by not performing the charge and discharge control in rainy weather when the adverse effects on the power grid 50 are small, a contrivance at lengthening the lifetime of the battery 3 is enabled.

Furthermore, in the first embodiment, as described above, the control initiating power output, for example, is 10% of the rated power output of the power generator 2. By enabling with this type of configuration, because the control initiating power output, which is the threshold on the occasion of initiating the charge and discharge control can be made greater than the power output on a rainy day, control is easily enabled wherein the charge and discharge control is not performed in rainy weather.

Moreover, in the first embodiment, as described above, when the controller 5 performs the charge and discharge control when the power output exceeds the control initiating fluctuation amount and, moreover, when the power output does not return to a power output in the vicinity of the power output before the fluctuation within the stand-by time. By enabling this type of configuration, when the fluctuation amount of the power output of the power generator 2 is less than the control initiating fluctuation amount, because the charge and discharge control is not performed, a reduction in the number of times the battery 3 is charged and discharged is enabled. Furthermore, even when the fluctuation amount of the power output of the power generator 2 is more than the control initiating fluctuation amount, when the power output does not return to a power output in the vicinity of the power output before the fluctuation within the stand-by time, because the charge and discharge control is not performed, a reduction in the number of times the battery 3 is charged and discharged is enabled. By this means, a contrivance at lengthening the lifetime of the battery 3 is enabled.

Furthermore, in the first embodiment, as described above, the control initiating fluctuation amount is set to be a fluctuation amount which is greater than the maximum fluctuation amount in each of the detection duration time interval at the time bands of midday in fine weather. By enabling this type of configuration, and by not performing the charge and discharge control in fine weather when the fluctuation amount of the power output is low for each detection duration time interval, while suppressing the effects caused by the fluctuation in the power output of the power generator 2 on the power grid 50, a decrease in the number of charge and discharge events is enabled. As a result, a contrivance at lengthening the lifetime of the battery 3 is enabled.

Moreover, in the first embodiment, as described above, the control initiation fluctuation amount is a fluctuation amount corresponding to 5% of the pre-fluctuation power output. By enabling this type of configuration, the control initiation fluctuation amount which is the threshold for the initiation of the charge and discharge control can easily be made greater than the maximum fluctuation amount in specific detection duration time intervals in time bands at midday on sunny days. Furthermore, the control initiating fluctuation amount may be derived based on the rated capacity of the power generator 2. Even when so enabled, the derivation of the same benefits as described above is enabled.

Furthermore, in the first embodiment, as described above, in the initial and final periods of charge and discharge control, the controller 5 shortens the acquisition period for power output data more than in the initial and final periods of the charge and discharge control, to compute the target output value. By enabling this type of configuration, the use of the power output on the initiation of the charge and discharge control, and the value of the power output before a very different abrupt fluctuation (before the charge and discharge control are initiated), in the computation of the target output value in the initial period of the charge and discharge control can be suppressed. By this means, the difference between the computed target output value and the actual power output on the initiation of the charge and discharge control can be made smaller.

Moreover, when the acquisition period of the power output data used in the computation of the moving average in the final periods of the charge and discharge control is made shorter than the periods other than the initial and final periods of the charge and discharge control, at the point where the charge and discharge control is terminated, because the computation of the target output value acquired only power output data in the vicinity of the termination point of the charge and discharge control, the amount of fluctuation in the power output to the power grid 50 before and after the termination of the charge and discharge control can be made smaller. As a result, the amount of fluctuation in the power output to the power grid 50 can be suppressed.

Furthermore, in the first embodiment, as described above, the controller 5 not only terminates the charge and discharge control after the initiation of the charge control and the expiry of the control period thereof, in addition to when there are fluctuations which are greater than the control initiating fluctuation amount on three or more occasions during the charge and discharge control, the control period of the charge and discharge control is extended. By enabling this type of configuration, because a reduction in the number of charge and discharge events is enabled compared with not terminating the charge and discharge control, a contrivance at extending the lifetime of the battery 3 is enabled. Moreover, when there is the expectation that the fluctuation in the power output would continue, the continuation of the charge and discharge control is enabled on the one hand, while enabling the suppression of the performance of charge and discharge control in periods where charge and discharge control is unnecessary, when the fluctuations in the power output do not continue. As a result, while reducing the charge and discharge event of the battery 3, the charge and discharge control can be performed effectively.

Next, a detailed explanation is provided on the results of a close examination of the effectiveness of the use of the solar power generation system 1, while referring to FIG. 7˜FIG. 13.

FIG. 7 shows the fluctuating transitions in one day of the amount of actual power output (output power) to the power grid in fine weather and fine weather with clouds. FIG. 7 shows the output power to the power grid 50 with no charge and discharge control (the actual raw power output of the power generator 2. In fine weather, because the light of the sun is not blocked by the clouds, the power output of the power generator 2 is sustained smoothly without any large fluctuation. On the other hand, it can be appreciated that in fine weather with clouds, the power output of the power generator 2 is sustained while being subject to repeated large fluctuations as a result of the fluctuation in the amount of incident sunlight due to the effects of the clouds.

FIG. 8 shows the trend of the amount of charging of battery cell 31 in a situation where the charge and discharge control is not performed. The maximum depth difference H1 in the electrical charge and discharge in fine weather is approximately 14% of the maximum charge and discharge amount of the battery cell, the maximum depth difference H2 in the electrical charge and discharge in fine weather with clouds is approximately 15% of the maximum charge and discharge amount of the battery cell. In other words, it can be appreciated that the size of the maximum depth difference of the amount of charge and discharge between fine weather and fine weather with clouds does not vary greatly.

The maximum depth difference in the electrical charge and discharge is known to have a big effect on the lifetime of the battery cell 31, but because the maximum depth difference does not vary greatly in fine weather and sunny weather, it can be understood that the lifetime of the battery cell 31 does not vary greatly in fine weather and fine weather with clouds. In other words, if the overall trends are substantially the same, notwithstanding the frequency of large fluctuations, it can be understood that the lifetime of the storage cells will not change.

Here, the effects which the output power pattern shown in FIG. 7 have on the power grid 50 are considered. In order to investigate the effects on the power grid 50, analysis was performed by means of FFT (fast Fourier transform) on each of the power output patterns shown in FIG. 7. FIG. 9 shows the results of the analysis. It can be appreciated that there is a significant difference between the power spectra of fine weather and fine weather with clouds. In particular, on watching the frequency domains of the numerical degrees of the load frequency control (LFC) domains, the size of power spectra in fine weather is about ¼ of fine weather with clouds. Therefore, if the charge and discharge control is not performed in fine weather, it can be appreciated that the fluctuations in the output will have little adverse effect on the power grid 50.

Next, the effects of the fluctuations in power output in rainy weather on the power grid 50 are considered. In FIG. 10 and FIG. 11, the trends in the fluctuation in the actual power output in one day of rainy weather and the results of the FFT analysis are represented. FIG. 10 shows the power output to the power grid 50 when the charge and discharge control are not performed (the power output just as it was output from the power generator 2)

As shown in FIG. 10, there are is a lot of fluctuation in the power output (Fluctuation in the generated power output) even in rainy weather. On the other hand, as shown in FIG. 11, it can be appreciated that the power spectra as a result of FFT analysis has become very small. In other words, it can be appreciated that if the charge and discharge control are not performed in rainy weather, the adverse effects on the power grid 50 are few.

From the facts above, as a result of FFT analysis, it was discovered that the necessity of performing charge and discharge control is low, because the power spectra in fine weather and rainy weather are small, and the adverse impact on the power grid 50 is small even if the charge and discharge control are not performed. Moreover, in respect of the size of the effects of the degree of depth of the charge and discharge on the lifetime of the battery cell 31, if the overall trend of the power output is substantially the same, it became clear that there was almost no difference between when the charge and discharge control was performed and when the charge and discharge control was not performed, notwithstanding the frequency of large fluctuations. Therefore, reduction in the frequency of the charge and discharge control is enabled by not performing charge and discharge control in fine weather and rainy weather. Hence, the lifetime of the battery cell can be lengthened.

Next, an explanation is provided on the investigation of the benefits of the alleviation of the adverse effects on the power grid as a result of the performance of the charge and discharge control.

In FIG. 12, the results of FFT analysis on comparative examples 1 and 2 and examples 1, 2 and 3 are represented. Comparative example 1 is an example where the charge and discharge control were not performed (Where the power output of power generator 2 was directly output to the power grid). Comparative example 2 is an example where charge and discharge control by means of a different general moving average method to the one employed in the first embodiment was performed all day long.

The general moving averages method is different from that of embodiment 1 wherein the number of samplings (sampling period) in the initial and final periods of the charge and discharge control, such that the control of the target output value is computed based on the same standard number of samplings, even at the initial and final periods of the charge and discharge control.

The examples 1˜3, just as in the first embodiment, the monitoring of the power output is initiated when the power output of the power generator 2 exceeds 10% of the rated power output, and the charge and discharge control is initiated when the power output fluctuation exceeds 5% of the power output before the fluctuation, in addition to not returning to the vicinity of the power output before the fluctuation within the stand-by time.

Moreover, in examples 1˜3, just as in the first embodiment, the charge and discharge control is performed reducing the number of samplings in the initial and final periods of the charge and discharge control. In addition, example 1, 2 and 3, in the determination of whether the power output returned to the vicinity of the power output before the fluctuation within the stand-by time, the stand-by time was set at 0, 1 and 2 minutes respectively.

As shown in FIG. 12, the power spectra of the FFT analysis result of comparative example 2 and examples 1˜3 are reduced compared to comparative example 1. In other words, in comparative example 2 and examples 1˜3, in a comparison with when the charge and discharge control was not performed (comparative example 1), the power spectra was greatly reduced. Moreover, in examples 1˜3, in comparison to when a general moving average method was used throughout the day (comparative example 2), because the same level of power output smoothing was enabled, it can be appreciated that the same degree of suppression of the adverse effects on the power grid 50 was enabled as was the case with the all-times, all-day general moving averages method. It can be concluded from the above that if the charge and discharge control is performed using that of the first embodiment, it is clear that the same degree of alleviation of adverse effects on the power grid system is enabled as when the charge and discharge control is performed at all hours in a day using the general moving averages method.

Here, a simple estimate of the results on the lifetime of battery cell 31 in comparative example 2 and examples 1˜3 is represented in Table 1. In this case, the total number of electrical charges and electrical discharges in each of comparative example 2 and examples 1˜3, based on approximately two months worth of power output data, is derived and the inverse thereof was used to estimate a value for the lifetime of the battery cells. The values for examples 1˜3 was standardized at the value for comparative example 2.

TABLE 1

| | Comparative | | | |
|---|---|---|---|---|
| | example 2 | Example 1 | Example 2 | Example 3 |
| The | 1 | 1.14 | 1.16 | 1.19 |
| estimated | | | | |
| value for the | | | | |
| battery | | | | |
| lifetime | | | | |

As shown in Table 1, with examples 1˜3, a lifetime extension of the battery lifetime of greater than 10% can be expected, compared to comparative example 2. Moreover, the estimated value for the lifetime was increased in examples 2 and 3, compared to example 1. This was because the period of the charge and discharge control was shorter, as a result of the provision of a stand-by time of 1 or 2 minutes, and it is considered that this is the result of the number of times of charge and discharge on battery cell 31 was reduced.

Next, the sampling period of the moving averages method was investigated.

FIG. 13 shows the FFT analysis results when the sampling period, which is the acquisition period for power output data, was set at 10 minutes and 20 minutes. When the sampling period was 10 minutes, the fluctuations whose fluctuation period was within the range of 10 minutes were suppressed, but it can be appreciated that the fluctuations whose fluctuation period was greater than 10 minutes were not suppressed. When the sampling period was 20 minutes, the fluctuations whose fluctuation period was within the range of 20 minutes were suppressed, but it can be appreciated that the fluctuations whose fluctuation period was greater than 20 minutes were not suppressed. Therefore, it can be appreciated that there is a good correlation between the length of the sampling period, and the fluctuation periods wherein the charge and discharge control effects suppression. As a result, it can be said that the control of the effective fluctuation period range changes with the setting of the sampling period.

In that event, in order to suppress the parts of the fluctuation periods which can be dealt with by load frequency control, it can be appreciated that it is preferable to set the sampling period longer than the fluctuation periods which can be dealt with by the load frequency control, especially to set the periods from the vicinity of the latter half of T1˜T2 (The vicinity of long periods) to periods with a range greater than T1. For example, In the example in FIG. 4, it can be appreciated that by setting the sampling period at greater than 20 minutes, almost all of the fluctuation periods which can be dealt with by the load frequency control can be suppressed. However, when the sampling period is made longer, there is a tendency for the size of the require storage capacity to increase, and it is preferable to set a sampling period which is not much longer than T1.

### Second Embodiment

The second embodiment in the present invention which is a solar power generation system is explained while referring to FIG. 14. In the first embodiment, an embodiment was explained wherein, after the control initiating fluctuation amount was detected, while in a state greater than the control initiation power output, the charge and discharge control was initiated if the power output did not return to power output before the fluctuation within a specific stand-by time. In distinction to this, in the second embodiment, an embodiment wherein charge and discharge control is soon initiated after a control initiating fluctuation is detected, while in a state which is greater than the control initiating power output. Now the configuration of the solar power generation system of the second embodiment, is the same as in embodiment one, other than the content of the control of the controller 5.

In respect of the flow of the control before the initiation of the charge and discharge control, a shown in FIG. 14, firstly, in Step S101, the controller 5, makes a determination as to whether the power output is greater than the control initiation power output or not. In the event that the power output is not less than the control initiation power output, that determination is repeated. In the event that the power output is not less than the control initiation power output, then in Step S102, the controller 5 initiates the monitoring of the fluctuation amounts of the power output. In other words, the difference between the detected power output and the immediately prior detected value for the power output is acquired as the fluctuation in the power output.

In Step S103, the controller 5 makes a determination as to whether the fluctuation in the power output is not less than the control initiating fluctuation amount. In the event that the fluctuation amount of the power output is not less than the control initiating fluctuation amount, that determination is repeated. Moreover, when the fluctuation amount of the power output is not less than the control initiating fluctuation amount the controller 5 immediately initiates charge and discharge control.

The charge and discharge control in the second embodiment is the same as the charge and discharge control of the first embodiment shown in FIG. 6.

The effects of the second embodiment are the same as those of the first embodiment which was described above.

### Third Embodiment

Next, the third embodiment in the present invention which is a power output system (solar power generation system 100) is explained while referring to FIG. 15.

In the solar power generation system 100, three power generators 2a, 2b and 2c comprising the solar cells generating power using sunlight, the battery 3, the power output unit 4 and the controller 15 are provided. The total power output of the power generators 2a, 2b and 2c is preferably less than the processable power output by power output unit 4.

The power generators 2a, 2b and 2c are connected in parallel in respect of the power output unit 4.

The DC-DC converters 7a, 7b and 7c have MPPT control functions. The DC-DC converters 7a, 7b and 7c are connected to each of the three power generators 2a, 2b and 2c. Each of the DC-DC converters 7a, 7b and 7c have the functions of converting the voltage of the power generated by the three power generators 2a, 2b and 2c to a fixed voltage and outputting to the power output unit 4 side. The DC-DC converters 7a, 7b and 7c are examples of the “first CD-DC converter” in the present invention.

The controller 15 includes the CPU 15a and the memory 15b. The controller 15 acquires the power output amounts of the detection units 8a, 8b and 8c provided on the output side of the DC-DC converters 7a, 7b and 7c of the power generators 2a, 2b and 2c. The controller 15 not only computes the target output value based on the total data of the power output amounts of the power generators 2a, 2b and 2c, but also performs the control of the battery cell 31 to compensate for the difference between the target output value and the total data of the power output amounts of the power generators 2a, 2b and 2c.

The configuration, other than the configuration described above, is the same as in the first embodiment.

In the third embodiment, as described above, the plural power generators 2a, 2b and 2c are provided, and the DC-DC converters 7a, 7b and 7c are provided in respect of the power generators 2a, 2b and 2c. By configuration in this manner, whereas in the first embodiment where only one power generator 2 was employed, and when only part of power generator 2 shaded such that the power output is reduces, in the third embodiment, even if one power generator 2a becomes shaded and the power output thereof is reduced, as long as the other power generators 2b and 2c do not become shaded, the reduction in the power output can be prevented. By this means, the suppression of the reduction of the total power output of the overall power output device is enabled. Because the suppression of the fluctuation of the power output is enabled by this means, the suppression of adverse effects on the power grid 50 is enabled.

The other effects of the third embodiment are the same as in the first embodiment.

Now the embodiments and examples disclosed here should be considered for the purposes of illustration in respect of all of their points and not limiting embodiments. The scope of the present invention is represented by the scope of the patent claims and not the embodiments described above, in addition to including all other modifications which have an equivalent meaning and fall within the scope of the patent claims.

For example, in the first to third embodiments described above, embodiments where solar cells were employed as the power generator 2 (the power generators 2a, 2b and 2c), but this invention is not limited to this, and other renewable energy power output devices such as wind power devices may be employed.

Moreover, in the first to third embodiments described above, embodiments were represented where lithium ion batteries or Ni-MH batteries were employed as the storage cell, but this invention is not limited to these, and may employ other secondary batteries. Furthermore, as an example of the “battery” of this invention, capacitors may be employed instead of the battery cells.

Furthermore, in the first to third embodiments described above, examples were disclosed wherein both of the sampling intervals in the starting time (initial period) and at the time of the termination (final period) of the charge and discharge control were made shorter, but this invention is not limited to these, and the sampling intervals in only one of either one of the starting time (initial period) and at the time of the termination (final period) of the charge and discharge control may be made shorter.

Moreover, in the third embodiment described above, an embodiment was described wherein DC-DC converters 7a˜7c were provided for each of three power generators 2a, 2b and 2c, but this invention is not limited to these, and one DC-DC converter may be connected to plural power output devices. For example, individual DC-DC converters may be connected to each of the power generators 2a, 2b and 2c, or one DC-DC converter may be connected to the power generators 2a, 2b, and a different DC-DC converter may be connected to the power generator 2c.

Furthermore, in the first to third embodiments described above, as examples of the “electrical charge means” and the “electrical discharge means” in the present invention, the DC-DC converters 33 and 34 were used, but this invention is not limited to these. In other words, one embodiment of the invention may employ apparatus other than DC-DC converters for the “electrical charge means” and the “electrical discharge means” in the present invention.

Moreover, in the first to third embodiments described above, an explanation was provided of embodiments where the voltage of the battery cell 31 was 48V, but this invention is not limited to this, and voltages other than 48 V may be employed. Now the voltage of the battery cell is preferably not more than 60V.

Furthermore, in the first to third embodiments described above, embodiments were described wherein the control initiating power output was set at 10% of the rate power output of the power generator 2, and the control initiating fluctuation amount was set at 5% of the pre-fluctuation amount, but this invention is not limited to these, and numerical values other than those described above may be employed. For example, the size of the control initiating power output is preferably greater than the size of the control initiating fluctuation amount.

Moreover, in the first to third embodiments described above, an explanation was provided whereby the stand-by time was not more than 2 minutes, but this invention is not limited to these, and may not be less than 2 minutes. Now the stand-by time is preferably not more than the upper limit period T1 of the fluctuation period of the loads which the load frequency control (LFC) can deal with, even more preferably not more than the lower limit period T2 of the fluctuation period of the loads which the load frequency control (LFC) can deal with. However, the lower limit period may vary due to the so-called run-in effect and the like of the power grid side. The degree of the run-in effect also varies with the prevalence and regional dispersibility of the solar power generating system.

Furthermore, in the first to third embodiments described above, embodiments were explained wherein the upper side threshold value and the lower side threshold value were set at 101% and 99% respectively of the pre-fluctuation value of the power output, in order to reach a determination as to whether there was a return to the pre-fluctuation level of power output, but the present invention is not limited to these, and values other than theses may be employed as the upper side threshold value and the lower side threshold value. Moreover, without varying the upper side threshold value and the lower side threshold value, the same value may be employed. For example, the pre-fluctuation power output and the same common threshold value for upper and lower side of the power output may be employed.

Furthermore, in the first to third embodiments described above, embodiments were explained wherein the upper side threshold value and the lower side threshold value were set at 1% of the pre-fluctuation value of the power output, but the present invention is not limited to these, and need not be 1% of the pre-fluctuation level of the power output. In the embodiments 1 and 3 described above, when the control initiating fluctuation amount was set as 5% of the pre-fluctuation amount, a threshold value was set in the range of 1% corresponding to the power output before the fluctuation, but this may be changed in accordance with changes in the intensity of control initiating fluctuation amount. For example, when the control initiating fluctuation amount is set at 10% of the rated output, a threshold value in the range of 2% of the pre-fluctuation power output may be set as the threshold value (such that the upper threshold value and the lower threshold value are set at 102% and 98% respectively, of the pre-fluctuation power output). Moreover, it is preferable that the threshold values (the upper threshold value and the lower threshold value) be set within 20% of the control initiating fluctuation amount.

Moreover, in the first to third embodiments described the monitoring was first initiated only when the power output is not less than the control initiating power output, but this invention is not limited to that, and a configuration whereby the fluctuation amount of the power output is always monitored may be enabled.

Furthermore, in the first to third embodiments described above, an explanation was provided whereby the power consumption in the consumer home was not taken into consideration in the load in the consumer home, but this invention is not limited to this, and in the computation of the target output value, a power is detected wherein at least part of the load is consumed at the consumer location, and the computation of the target output value is performed considering that load consumed power output or the fluctuation in the load consumed power output.

Moreover, in the sampling intervals described in the first to third embodiments, in regard to the specific values of the bus voltages and the like, they are not limited to these in this invention, and may be appropriately modified.

Furthermore, In the third embodiment described above, an embodiment was described wherein a power output detection means was provided on each of the power output devices, but this invention is not limited to this, and one power output detection means may be provided in respect of the three power output devices.

1. An electrical charge and discharge system, comprising:
a battery connected to a bus to which multiple power a generator and an electric power transmission system are connected;
a charger configured to supply power from the bus to the battery;
a discharger separate from the charger and configured to output electric power from the battery to the bus; and
a controller configured to separately control the charger and the discharger.

2. The system of claim 1, further comprising a first DC-DC converter connected in series between the power generator and the electric power transmission system.

3. The system of claim 1, wherein the charger comprises a second DC-DC converter for use in charging the battery and the discharger comprises a third DC-DC converter for use in charging the battery.

4. The system of claim 1, wherein the charger comprises a first rectifier configured to regulate a direction of current flow to a charging direction of the battery and the discharger comprises a second rectifier configured to regulate a direction of current flow to a discharge direction of the battery.

5. The system of claim 2, wherein a plurality of power generators are connected in parallel with respect to the bus, and the first DC-DC converter is connected to each of the multiple power generators or the first DC-DC converter comprises multiple DC-DC converters so that each of the multiple DC-DC converters is connected to a corresponding power generator.

6. The system of claim 1, wherein the controller is configured to control the charger and discharger to compensate for a difference between actual power output from the power generator and target output value to be output to the electric power transmission system.

7. The system of claim 6, wherein the controller is configured to control the charger such that electric power corresponding to a difference between the actual power and the target output value is charged to the battery when the actual power is greater than the target output value and to control the discharger such that electric power corresponding to a difference between the actual power and the target output value is discharged from the battery to the electric power transmission system when the actual power is less than the target output value.

8. The system of claim 6, further comprising:
a first DC-DC converter connected in series between the power generator and the electric power transmission system and configured to convert power at a first DC voltage generated by the power generator to power at a second DC voltage; and
a power output detector configured to detect the power at the second DC voltage as the actual power output from the multiple power generators,
wherein the controller is configured to calculate the target output value to be output to the electrical power transmission system and to control the charger and discharger to compensate for a power difference corresponding to a difference between the target output value and the actual power detected by the power output detector.

9. The system of claim 8, wherein the controller is configured to control the charger and discharger when the actual power detected by the power output detector is above a predetermined power output amount and a fluctuation amount of the actual power detected by the power output detector is above a predetermined fluctuation amount.

10. The system of claim 9, wherein the first DC-DC converter is connected to the power generator that is a solar power generator and the predetermined power output amount is a value greater than power output by the solar power generator during rainy weather.

11. The system of claim 9, wherein the predetermined power output amount is 10% of a rated power output of the power generator.

12. The system of claim 8, wherein the controller is configured to control the charger and discharger when the actual power detected by the power output detector is greater than a predetermined fluctuation amount and the actual power does not return to an amount of power output before the fluctuation within a predetermined period of time.

13. The system of claim 9, wherein
the first DC-DC converter is connected to the power generator that is a solar power generator, and
the controller is configured to acquire actual power output by the solar power generator at specific detection time intervals and to make a determination as to whether a fluctuation amount of the actual power output by the solar power generator is greater than the predetermined fluctuation amount, the predetermined fluctuation amount being greater than a maximum fluctuation amount during the specific detection time intervals in a midday hour during sunny weather.

14. The system of claim 13, wherein the predetermined fluctuation amount is 5% of power output before the fluctuation.

15. The system of claim 8, wherein the controller is configured to calculate the target output value using a moving averages method and shorten an acquisition period of power output data in the computation of the target output value in respect of at least one of an initial period and a final period rather than of periods which are periods other than the initial period and the final period.

16. The system of claim 9, wherein the controller is configured to terminate control of the charger and discharger after expiration of a second period from initiation of control except when fluctuations of the actual power above the predetermined fluctuation amount are detected by the detector a predetermined number of times since initiation.

17. A method of managing a battery and a power generator, comprising:
detecting power outputted from the power generator;
determining target output value to be supplied to an electric power transmission system; and
controlling the battery so that electric power corresponding to a difference between the detected power and the target output value is charged to the battery when the detected power is greater than the target output value and that electric power corresponding to a difference between the detected power and the target output value is discharged from the battery to the electric power transmission system when the detected power is smaller than the target output value.

18. The method of claim 17, wherein the control of the battery is performed upon a determination that the detected power is above a predetermined power output amount and a fluctuation amount of the detected power is above a predetermined fluctuation amount.

19. The method of claim 17, wherein the target output value is calculated using a moving averages method and an acquisition period of power outputted from the power generator is shortened in the determination of the target output value in respect of at least one of an initial period and a final period rather than of periods which are periods other than the initial period and the final period.

20. A computer-readable recording medium which records a control program for causing one or more computers to perform the steps comprising:
receiving a result of detection of power outputted from a power generator;
calculating target output value to be supplied to an electric power transmission system; and
controlling a battery so that electric power corresponding to a difference between the detected power and the target output value is charged to the battery when the detected power is greater than the target output value and that electric power corresponding to a difference between the detected power and the target output value is discharged from the battery to the electric power transmission system when the detected power is smaller than the target output value.

21. A device managing a battery, comprising:
a charger configured to supply power to the battery;
a discharger separate from the charger and configured to output electric power to an electric power transmission system; and
a controller configured to control the charge and the discharger so that electric power corresponding to a difference between power generated by a generator and target output value to be supplied to the electric power transmission system is charged to the battery when the generated power is greater than the target output value and that electric power corresponding to a difference between the generated power and the target output value is discharged from the battery to the electric power transmission system when the generated power is smaller than the target output value.
